(19) United States
(12) Patent Application Publication
(10) Pub. No.: US 2005/0214547 A1
(43) Pub. Date: Sep. 29, 2005

(54) Method for thermal insulation, method for preparation of an insulating gel and insulating gel produced thus

(76) Inventors: David Pasquier, Billancourt (FR); Angele Chomard, Paris (FR); Jacques Jarrin, Nanterre (FR); Valerie Ozoux, Nevers (FR)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/516,610

(22) PCT Filed: Jun. 2, 2003
(86) PCT No.: PCT/FR03/01652

§ 371 Date: May 25, 2005

(30) Foreign Application Priority Data
Jun. 3, 2002 (FR) 02/06814

(51) Int. Cl. B32B 9/04

(52) U.S. Cl. 428/447

(57) ABSTRACT

A method for thermal insulation comprises positioning a gel formed between an insulating liquid base, which may or may not be a phase change material, and at least one gelling agent comprising at least one polysiloxane, which may or may not be modified, and in situ cross linking of the gelling agent, optionally in the presence of at least one compatibilizing agent. More particularly, it is used to insulate a flowline or a pipeline, in particular for ultradeep operations at temperatures of 2° C. to 200° C. Cross-linkable formulations, the various cross-linking processes and the insulating gels obtained are described.

The present invention relates to the field of thermal insulation materials, in particular for exploitation and transport of effluents produced by an oil field.

It concerns a thermal insulation method characterized in that it comprises positioning a gel formed between an insulating liquid base, which may or may not be a phase change material, and at least one gelling agent comprising at least one polysiloxane, which may or may not be modified, and in situ cross linking of the gelling agent, optionally in the presence of at least one compatibilizing agent. The term “in situ” as used in the present description means that gel formation (cross-linking) conditions are applied after the formulation giving rise to the gel has been positioned in the space in which the gel is to exert its insulating effect.

The invention also relates to cross-linkable formulations for use in said insulating method, to a process for preparing insulating gels by cross-linking said formulations, and to the gels obtained.

The thermal insulation method of the invention can be applied in a number of fields, in particular for thermal insulation of flowlines or pipelines or singularities such as a bend, a tee, a valve or an automatic connector, in which fluids that can substantially change their state with temperature are moving: paraffin crystallization, hydrate deposition, ice, etc.

This is particular the case in the hydrocarbon production field. Thermal insulation of submarine flowlines is often necessary to keep fluids flowing and to avoid, for as long as possible, the formation of hydrates or deposits that are rich in paraffins or asphaltenes. Effective thermal insulation can keep the fluid flowing over the entire length of the line.

Organic liquids are the compounds of choice for thermal insulation because of their low thermal conductivity and can also have phase change properties. However, convection phenomena are involved, causing an increase in heat loss. Gelling those liquids can ensure low thermal conductivity (gels are mainly composed of liquid) while limiting or avoiding convection because of gelling.

In the event of a production stoppage, the use of phase change insulating gels can increase the down time without any risk of plugging the flowlines by premature cooling of their contents. Phase change materials (PCM) behave as heat accumulators. They reversibly restore this energy during solidification (crystallization) or absorb this energy during melting.

In the case of insulating materials which may or may not be phase change materials, different insulating techniques have been described, for example, in the following documents: French patent application FR-A-2 809 115, Japanese patent application JP-A-02/176 299 (patent JP-B-91/068 275) and International patent application WO-A-97/47 174.

Thermal insulation can be achieved by different processes. On dry land or at shallow depths, cellular or woolly porous solid materials blocking the convection of gas with a low thermal conductivity are used. The compressibility of said porous materials prohibits the use of that technique at relatively great depths.

Other solutions exist which are better suited to great immersion depths. As an example, it is possible to use:
coatings of almost incompressible polymers based on polyurethane, polyethylene, polypropylene, etc., which have a medium thermal resistivity, which is insufficient to avoid problems in the event of stoppages;
coatings of syntactic materials constituted by hollow beads containing a gas, which resist external pressure, embedded in binders such as concrete, epoxy resin, etc, with a lower conductivity than compact materials, but which are substantially more expensive. Said materials can risk degradation under the simultaneous action of temperature and hydrostatic pressure when these are high;

It is also possible to protect the flowline in which the fluids are moving by an external jacket that is resistant to hydrostatic pressure. In the annular space formed, a low thermal conductivity heat insulating material can be interposed, for example, which is subject to atmospheric pressure or placed under vacuum with barriers placed at regular intervals for safety reasons.

Glycols gelled by polysaccharides (sold under the trade name BIOZAN®) can be employed for thermal insulation of fluid transports and pipelines (United States patents U.S. Pat. No. 5,290,768 and U.S. Pat. No. 5,876,619). The matrix is formed by electrostatic interaction of the side chain carboxylate groups of the polysaccharides with multivalent cations present in the medium, with the addition of a complexing agent to control the quantity of ions. If the concentration of multivalent cations increases in the gel (for example because of corrosion of the metal walls) beyond the concentration of complexing agent, the gel shrinks. Macrosineresis (phase macroseparation then occurs, and the insulating base (in this case a glycol) is partially expelled. Convection is no longer effectively blocked.

Other gels based on polyols (polyethylene glycol, polypropylene glycol or glycerin) have an application in thermal insulation by reducing the convection flow as described, for example, in U.S. Pat. No. 5,951,910. In that document, the gelling agent is a cross-linked bacterial cellulose consisting of a three-dimensional matrix of interconnecting fibres, insoluble in water. Additives can optionally be used, in particular a co-agent such as a cellulose polymer that is soluble in water which interacts with the surface of the cellulose. It prevents flocculation by acting as a dispersing agent (for example carboxymethylcellulose, CMC). Similarly, corrosion inhibitors or metal chelating agents can optionally be used. In that case, the water solubility of the cellulose polymer constitutes a risk for an offshore application.

A priori, chemical gels possess better temperature parameters. A gel based on kerosene, the gelling agent for which is KEN PAK® from Imco Service (the condensation product of a polyol with an aromatic monoaldehyde), is used for thermal insulation of “submarine bundle” type pipelines (U.S. Pat. No. 4,941,773). That gel is difficult to use because of its high viscosity and it produces water during the gelling reaction.

It has been established that existing insulating gel solutions, which may or may not be phase change materials, are difficult to use and/or have a long term service life limited by:
decantation phenomena (suspensions of particles);
or by stabilization agent saturation phenomena (ion complexing agents in the case of polysaccharide gels);
or because of a certain water solubility of the gelling agent;
or by compatibility problems between the insulating base and the gelling agent;
or because of a high sensitivity to oxidation.

Temperature is also a limiting parameter for existing solutions.

We have now discovered a novel method for thermal insulation by positioning a chemical gel, using an organic insulating liquid base and at least one polysiloxane as the gelling agent.

The advantage of such a gelling agent is that it has a polysiloxane skeleton that endows it with very good thermal behaviour. Its properties and those of the gel obtained are stable over a wide temperature range and, in the absence of oxygen, degradation only occurs above 350° C. Further, it is possible to adapt its solubility by suitable functionalization of the polysiloxanes and to optimize the chemical compatibility between the insulating base and the gelling agent. The production of a high affinity greatly reduces the risks of long term demixing (macrosineresis). Further, it does not oxidize. Finally, the presence of metal ions, water or biological molecules does not modify the properties of the insulating gel obtained.

Other characteristics and advantages of the process and the insulating material of the invention and examples of application will be given below.

Thus, in a first aspect, the invention provides a thermal insulation method that can be defined as comprising positioning a gel formed between an insulating liquid constituent or base, which may or may not be a phase change material, and at least one gelling agent comprising at least one polysiloxane resin, which may or may not be modified, followed by in situ cross linking of said polysiloxane resin.

The insulating liquid base, which constitutes the continuous phase, may or may not be a phase change material. In general, it consists of an organic liquid, preferably apolar, to increase its insulating capacity. The following examples from many liquid bases that can be used can be cited:
saturated or unsaturated, cyclic or non-cyclic aliphatic hydrocarbon bases;
aromatic hydrocarbon bases: benzene, xylene, mesitylene, etc.;
mixtures of aliphatic and aromatic fractions: petroleum cuts such as paraffinic, kerosene, gas oil cuts, etc;
aliphatic or aromatic alcohols;
fatty acids and vegetable oils (for example palm oil, castor oil, etc) or animal oils; and
halogenated compounds.

Any insulating liquid with a low thermal conductivity and a boiling point that is above the working temperature is suitable. A low saturated vapour tension is an advantage for this application.

More particularly, the insulating base is a phase change material (PCM). Non-limiting examples of phase change materials that can be cited are chemical compounds from the alkane family CₙH₂ₙ₊₂, such as paraffins (for example C₁₂ to C₆₀), which exhibit a good compromise between the thermal and thermodynamic properties (melting point, latent heat of fusion, thermal conductivity, thermal capacity) and cost. Said compounds are thermally stable over the envisaged service temperature range and they are compatible with use in a marine environment because of their insolubility in water and their very low toxicity. Thus, they are well suited to thermal insulation of ultradeep flowlines.

The temperature at which the state of said phase change materials changes is linked to the number of carbon atoms in the hydrocarbon chain. The temperature can thus be adapted to a particular application by selecting the hydrocarbon chain. In the case of phase change materials, in addition to these criteria, a state change temperature in the range 15° C. to 35° C. is preferable. To obtain a phase change at about 25° C., a mixture of mainly C₁₈ paraffins can be used such as LINPAR 18-20® sold by CONDEA Augusta SpA.

It is also possible to consider the use of very slightly branched (1 or 2 branches) long chain (C₃₀ to C₄₀) n-paraffins or isoparaffins, long alkyl chain slightly branched alkylaromatics or alkylcycloalkanes, fatty alcohols or fatty acids. Similarly, mixtures of said products are suitable.

The silicone resins (or polysiloxanes) used in the composition of the gelling agent in the method of the invention are preferably:
monomers containing a motif with formula (I) terminated by two motifs with formula (II);
oligomers with unitary motifs with formula (I) terminated by motifs with formula (II);
polymers comprising unitary motifs with formula (I) terminated by motifs with formula (II);
cyclic oligomers comprising unitary motifs with formula (I); and
cyclic polymers comprising unitary motifs with formula (I); formulae (I) and (II) being shown below: 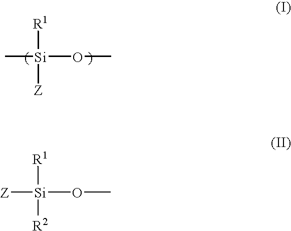
   in which formulae:
symbols R¹ and R² are identical or different and each represent:
   a linear or branched alkyl radical containing less than 30 carbon atoms, optionally substituted with at least one halogen, the alkyl radicals preferably being methyl, ethyl, propyl or octyl;
   a cycloalkyl radical containing 5 to 8 carbon atoms in the cycle, optionally substituted;
   an aryl radical containing 6 to 12 carbon atoms, which may be substituted, preferably a phenyl or dichlorophenyl radical; or
   any other alkylaromatic chain;.
symbols Z are identical or different and each represent;
   a group R¹ and/or R²;
   a hydrogen radical;
   a hydroxyl radical;
   a vinyl radical (—CH═CH₂); or
   a saturated or unsaturated, aliphatic or cyclic carbonaceous chain which may or may not contain unsaturated bonds, which may or may not contain heteroatoms, which may or may not contain reactive chemical groups (such as amine, carboxylic acid, aldehyde, alcohols, ether, epoxy, oxetane, alkenylether, thiol or thioether);
with at least one of symbols Z representing a cross-linkable group which can differ depending on the cross-linking mode used in the modes envisaged below.

In the mixture used in the insulation method of the invention, the liquid insulating base generally represents 50% to 99.5% of the total mixture weight and the gelling agent represents 50% to 0.5%.

In some cases, it may be necessary to introduce a compatibilizing agent into the mixture to be positioned. The agent generally consists of:
either a molecule or a macromolecule acting as a surfactant between the polysiloxane gelling agent and the insulating liquid base; it may be a diblock (PDMS-PE) or triblock (PE-PDMS-PE) polydimethylsiloxane-polyethylene copolymer;
or a molecule with the same nature as the insulating liquid base that can be grafted onto the polysiloxanes during cross-linking. In that case, the compatibilizing agent forms an integral part of the gelling agent (polysiloxanes), since the polysiloxanes have been modified thereby.

Depending on the nature of the polysiloxane resin used, cross-linking of the gelling agent, carried out in the mixture formed with the insulating liquid base and optionally employing a compatibilizing agent, can be carried out in different manners, as described below.

In the first mode, the polysiloxanes can be cross-linked directly by condensing Si—H bonds onto silanol functions (Si—OH) in the presence of a metal catalyst (for example a platinum-based or a tin carboxylate catalyst). The reaction can be represented by the following equation:
R₃Si—H+HO—SiR′₃→R₃SiOSiR′₃+H₂

In this case, the polyorganosiloxane used in the composition of the gelling agent must include motifs with formulae (I) and/or (II) above in which a plurality of symbols Z represent the hydroxyl radical.

In a second mode, polyorganosiloxanes terminated by hydroxyl functions are generally cross-linked using a silane having alkoxy functions or carboxylate groups. This reaction necessitates the addition of an acid catalyst (for example acetic acid or trichloroacetic acid), a basic catalyst (triethylamine) or a tin or titanium-based catalyst. This reaction also necessitates the intervention of trace amounts of water, which acts as a co-catalyst. This process is used a great deal in manufacturing silicone seals. In this case, the polyorganosiloxane used in the composition of the gelling agent must contain motifs with formulae (I) and/or (II) above in which a plurality of symbols Z represent the hydroxyl radical.

In a third mode, cross-linking is carried out by addition. A two-constituent system is then generally used:
a polysiloxane resin containing vinyl functions (Si—CH═CH₂) with which a catalyst, for example platinum, has generally been mixed;
and another polysiloxane resin containing Si—H functions.

The reaction is rapid. The reaction temperature can be from 20° C. to 150° C. The distance between cross-linking nodes is defined by the distance between reactive groups (Si—H and Si—CH═CH₂) in each resin. The principal advantage of this process resides in the absence of reaction by-products. In this case, the two polyorganosiloxanes involved in the composition of the gelling agent must contain motifs with formulae (I) and/or (II) above in which a plurality of symbols Z represent the hydrogen radical and the vinyl radical respectively. A hydrosilylation catalyst is generally included in the formulation.

In a fourth mode, high temperature cross-linking is carried out, initiated by radical species. Peroxides, such as benzoyl peroxide or t-butyl peroxide, provide said radicals. The cross-linking temperature depends on the dissociation energy of the peroxide bond in the selected initiator. Vinyl groups are more reactive towards radicals than alkanes. In this case, the polyorganosiloxane in the gelling agent composition can comprise motifs with formulae (I) and/or (II) above in which a plurality of symbols Z represent a vinyl radical. Other radical systems will allow cross-linking. This is the case with photo-initiated systems, which follow a mechanism that is analogous to that of peroxides; activation occurs by UV radiation and not thermally.

In a fifth mode, thermal cross-linking is carried out in the presence of an ionic initiator. When the polyorganosiloxane includes certain motifs (I) and/or (II) containing groups Z comprising epoxy or oxetane groups, it is possible to cross-link said polymer using an ionic polymerization initiator that is activated thermally (for example as described in FR-A-2 800 380). The cross-linking/polymerization process then involves ionic opening of the epoxy or oxetane rings.

In the preferred insulation method of the invention, cross-linking is carried out using the third mode described above: in situ cross-linking by hydrosilylation. It comprises using a gelling agent constituted by two functionalized polysiloxane resins, one containing hydrosilane (Si—H) functions and the other containing vinylsilane functions (Si-vinyl)—which may be grafted, and which can be cross-linked by polyaddition (hydrosilylation in the presence of a platinum catalyst).

One advantage of this cross-linking mode is that, in contrast to systems cross-linked by polycondensation, polysiloxanes cross-linked by polyaddition (hydrosilylation) produce no volatile compounds during cross-linking, which renders them easier to use in a confined medium.

Further, a combination of such a gelling agent with the insulating base, which may or may not be a phase change material, forms a gelled structure that is stable over time and stable over a wide temperature range.

The first resin, A, comprises pendent Si-vinyl functions. Chemical motifs that are routinely encountered in this first resin are: —Si(CH₃)₂O—, —Si(CH═CH₂)CH₃O—, possibly —Si(C₆H₅)₂O— and possibly —SiCH₃R¹ O—, where R¹ is a carbon chain that may contain heteroatoms, cycles or aromatic groups.

The second resin, B, contains the Si—H functions, which will react with the Si-vinyl functions in the first resin to cross-link. The chemical motifs that are routinely encountered in resin B are: —Si(CH₃)₂O—, —SiHCH₃O—, possibly —Si(C₆H₅)₂O— and possibly —SiCH₃R¹O—, where R¹ is a carbon chain that may contain heteroatoms, cycles or aromatic groups.

To control the cross-linking reaction kinetics, the gelling agent used in this cross-linking mode can comprise a hydrosilylation catalyst based on a transition metal (for example platinum). It is generally introduced into the formulation for resin A. It can, for example, be hexachloroplatinic acid or a Pt⁽⁰⁾-divinyltetramethyldisiloxane complex or a Pt⁽⁰⁾-tetramethyltetravinylcyclotetrasiloxane complex. The quantity of this hydrosilylation catalyst can be between 1 ×10⁻⁸ and 1 ×10⁻² equivalents with respect to the double bonds present (deriving from resin B and from an optional compatibilizing agent), depending on the presence of heteroatoms with electron pairs and depending on the concentration.

More particularly, it is possible to use bi-component ambient temperature cross-linkable systems such as RTV 141® from Rhodia or SYLGARD 182® or DOW-CORNING 3-4235® from Dow Corning, which are suitable for the method of the invention. Along with component B for these resins, it is possible to use other polysiloxanes containing Si—H functions such as polyhydromethylsiloxanes known as PHMS.

The two polysiloxane resins (one containing Si-vinyl functions (resin A) and the other containing Si—H functions (resin B)) are cross-linked in a dilute medium at a temperature in the range 20° C. to 150° C. The chains are extended by the insulating liquid base, which acts as a solvent. A large quantity of base can be gelled by the polysiloxane elastomer formed in situ, i.e., in a dilute medium. The mechanical properties of the gel obtained are not important as long as the insulating liquid base remains in the gel, i.e., macrosineresis (demixing) remains small. Macrosineresis is limited when the concentration of gelling agent (polysiloxane elastomer) in the base is above the limiting gel equilibrium concentration. The factors governing this limiting concentration are connected to the interaction between the gelling agent and the base, which is a function of the solubility of the polysiloxane chains and the insulating liquid base, but also of the degree of cross-linking of the polysiloxane matrix (and thus of the inter-node distance).

The ratio of the quantities of the two resins is determined by the RHV, i.e., the ratio of the molar quantities of the Si—H groups deriving from resin B and the Si-vinyl groups deriving from resin A. The optimum RIV is located in the range 0.8 to 1.4. It is preferably close to 1.2.

As an example, for RTV 141® systems, and for SYLGARD 182® systems, the preferred proportion by weight of resin A and resin B is about 10/1; for DOW-CORNING 3-4235®, it is about 1/1.

The concentration of gelling agent in the mixture used in the method of the invention in the insulating base can be between 0.5% and 50%, but is preferably in the range 2% to 30% and more preferably in the range 7% to 30%. It depends on the characteristics of the polysiloxane resin used.

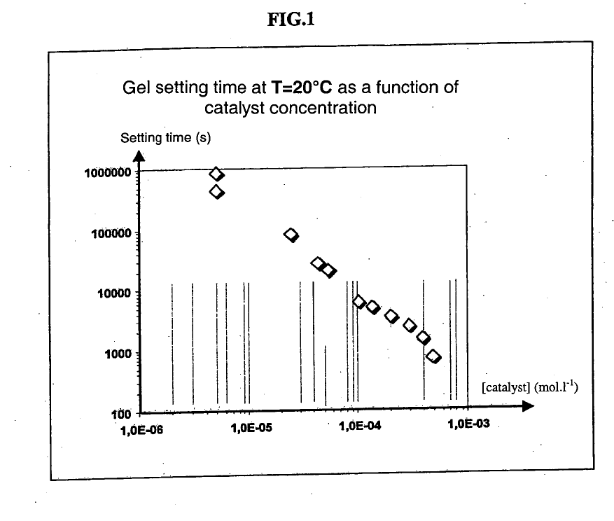

The gel time varies and essentially depends on the temperature employed, the concentration of gelling agent (resins A and B) and on the catalyst concentration, FIG. 1.

In the. case of cross-linking by hydrosilylation as described above, the compatiblizing agent when used generally consists of a vinyl compound that is highly compatible with the insulating base. In the same way as the Si-vinyl functions of the polysiloxane resin, this vinyl compound can then react during cross-linking with the Si—H bonds of the other resin. Thus, the polysiloxane matrix is modified in situ by hydrosilylation grafting of the compatiblizing groups.

The fact that the hydrosilane functions consumed by grafting the compatiblizing agent can no longer take part in cross-linking and node formation is taken into account. The formulation is adapted to provide sufficient hydrosilane functions to ensure grafting of the compatiblizing agent and cross-linking.

The compatiblizing agent can, for example, consist of a hydrocarbon compound comprising a terminal unsaturated bond such as octadec-1-ene, for example when a paraffin is used as the insulating liquid base, or allylbenzene, for example, when a composition with an aromatic nature is used as the insulating liquid base.

The cross-linkable formulations that can be used in the thermal insulation method of the invention can be defined by the fact that they generally comprise a mixture of an insulating liquid base, which may or may not be a phase change material, and at least one gelling agent comprising at least one polysiloxane, which may or may not be modified.

The insulating liquid bases, gelling agents and any compatiblizing agents that can be used in these formulations were described above. More particular mention can be made of such formulations in which the insulating liquid base is selected from kerosenes (aromatic or non aromatic) and paraffins, for example C₁₄ to C₂₀.

When the insulating liquid base essentially consists of a kerosene, it is not necessary to use a compatibilizing agent as the solubility of kerosenes is very close to that of polysiloxanes, whether they are linear or cross-linked. In these formulations, a concentration of gelling agent of 5% to 30% by weight is generally sufficient to obtain a stable gel for an insulating liquid base (kerosene 95% to 70% by weight). These proportions are valid for kerosenes that may or may not comprise aromatic constituents.

When the insulating liquid base essentially consists of a paraffin or a mixture of paraffins (for example a C₁₄ to C₂₀ paraffin cut), a compatibilizing agent is generally used to improve the stability of the gel and to avoid paraffin washout. As an example, it can be a compound with a terminal unsaturated bond, such as octadec-1-ene. The concentration of gelling agent (polysiloxane) which can be 7% to 30% by weight, for example (for a paraffin concentration of 93% to 70%) includes that of the compatibilizing agent which can, for example, be in a proportion of 10% to 40% by weight of the total concentration of gelling agent+compatibilizing agent.

Regardless of the cross-linking mode used, in order to provide certain specific properties required in order to use the gel, it is possible to add compounds that act as additives and/or fillers that are suitable for certain applications to the mixture of the insulating liquid base and the gelling agent.

Hence, it is possible to add soluble additives with the following functions:
antioxidant additives can be added essentially when the gel is subjected to a rise in service temperature. The most usual additives are phenolic derivatives (dibutylparacresol, etc), phenolic derivatives containing sulphur and aromatic amines (phenyl α- or β- naphthylanine or alkylated diphenylamines). Said antioxidants retard the oxidation process thanks to their inhibition of free radical formation, or their destruction of the hydroperoxides formed;
antibacterial agents;
corrosion inhibitors that are soluble in the insulating liquid base. They are constituted by chemical compounds that are readily adsorbed onto a metal surface, forming a hydrophobic film (fatty amines, alkaline-earth metal sulphonates or phosphonates, etc);
or anti-foaming agents or colorants.

It is also possible to add insoluble fillers to the mixtures, for example hollow glass microbeads, fly ash, macrobeads, hollow fibres, etc, to adjust its density and/or its thermal conductivity.

The gels of the invention are applicable to thermal insulation in general. They can in particular be applied to the thermal insulation of hydrocarbon flowlines where they are used as direct or interposed (injected) coatings between the flowlines and an external protective jacket, or for thermal insulation of singularities such as a bend, tee, valve or automatic connector. In the latter case, the singularity is a flowline already in position on the seabed, and a jacket or sealed casing is placed around said singularity using a remote controlled submarine robot (ROV type) provided with manipulating arms. A vacuum is then created in said jacket to purge as much of the residual water it may contain as possible and the final mixture is prepared in the ROV and activated by heating if necessary, then injected into the jacket to inflate it and to create the desired insulation around said singularity. Preferred formulations from those mentioned above are those which can cross-link at low temperatures.

The innovative nature of the method of the invention thus resides in the use of polysiloxane elastomers as gelling agents. Polysiloxanes are cross-linked in the presence of a insulating liquid base. Using a polysiloxane as the gelling agent has a plurality of advantages:
a) the polysiloxane is selected as a function of the insulating liquid base to be gelled, which allows maximum compatibility between the base and the gelling matrix and thus very good stability over time;
   linear polysiloxanes and polysiloxane elastomers are highly compatible with aliphatic hydrocarbons such as kerosenes or paraffins. Their solubility coefficients are very close. Thus, good thermodynamic compatibility is obtained between the gelling polysiloxane and the liquid hydrocarbon base. A low concentration of gelling agent is sufficient and long term stability is ensured;
   if the compatibility between the insulating liquid base is not optimal, a grafted polysiloxane is selected to maximize the compatibility between the base and the gelling matrix and thus to provide good long term stability. In contrast, in the case of an aromatic insulating base, a polysiloxane with aromatic motifs is used (for example Si(C₆H₅)₂O or SiCH₃R¹O in which R¹ is a group containing an aromatic motif).
b) compared with polymers with a carbon skeleton, polysiloxanes are exceptionally stable to temperature. Their physical properties vary only very slightly with temperature over quite a wide range: −150° C. to 150° C., with polysiloxane degradation only commencing at 350° C.;
c) polysiloxanes are perfectly biocompatible as they do not modify any biological metabolisms;
d) cross-linking can be carried out at ambient temperature and up to 150° C. This means that the service temperature range for the gels is wide;
e) the process employs low viscosity silicone oils diluted in an insulating liquid base. This facilitates its use;
f) the cross-linking kinetics depend on the concentration of the polymers in the insulating liquid base, on the temperature and the nature and concentration of the catalyst if used. It can be from a few hours to several days for low temperatures and low polysiloxane concentrations. This provides a wide range of gel times as a function of the desired processing time.

The invention also concerns a process for chemical gelling of insulating liquid bases which may or may not be phase change materials (PCM), to form chemically cross-linked gels that are stable over a wide temperature and time range.

The process of the invention can produce an insulating gel based on a chemically cross-linked polysiloxane with a low thermal conductivity, which may or may not be a phase change material, which remains stable over time and over a wide temperature range.

The manufacturing process thus consists of gelling an insulating liquid base, which may or may not be a phase change material, using a silicone gelling agent selected to sufficiently increase the viscosity of the insulating liquid base, which may or may not be a phase change material, so as to reduce or stop thermal convection in the insulating base in the liquid state.

The insulating properties of the gels obtained by the process are thus durable in aqueous media; they are also stable to temperature.

The gels obtained by the process are easy to use and the reaction can readily be controlled. The gel time can be adapted by controlling the reaction temperature and the quantity of catalyst. The reaction occurs without volatiles formation, which means that it can be carried out in a confined medium, for example between a flowline and an external jacket or in a jacket surrounding a singularity such as an elbow, a tee, a valve or an automatic connector.

The following examples illustrate the invention without limiting its scope. Resins A and B used in the examples are components A and B of RTV 141® resin from Rhodia. A hydrosilylation catalyst is included in resin A. In Example 6, a supplemental quantity of Pt⁽⁰⁾ divinyl-tetramethyldisiloxane is added.

### EXAMPLE 1

90.2 g of a C₁₈-C₂₀ paraffin was heated to 80° C., and 18 g of resin A was added followed by 1.8 g of resin B, with stirring. The mixture was stirred until it was homogeneous and the temperature was kept at 80° C. The time to gelling was a period of about 1 hour which was used to position the gel in the receptacle or flowline. Once in place, the gel set irreversibly in the receptacle or flowline with negligible shrinkage. The energy restoration phenomenon appeared on cooling during the liquid-solid transition of the paraffin.

### EXAMPLE 2

50.1 g of a KETRUL 212® kerosene (containing 20% aromatics) was mixed with 4.5 g of resin A. 0.5 g of resin B was then added. The mixture was stirred until it was homogeneous and the temperature was kept at 80° C. The time to gelling was a period of about 1 hour which was used to position the gel in the receptacle or flowline. Once in place, the gel set irreversibly in the receptacle or flowline with negligible shrinkage.

### EXAMPLE 3

46.74 g of (C₁₄-C₂₀) paraffin was added to 8.96 g of resin A and 0.26 g of octadec-1-ene. The mixture was stirred, then 1.30 g of resin B was added. The mixture was stirred until it was homogeneous and the temperature was kept at 60° C. The time to gelling was a period of about 24 hours which was used to position the gel in the receptacle or flowline. Once in place, the gel set irreversibly in the receptacle or flowline with negligible shrinkage. The temperature (lower than for Example 1) provided a longer time period for positioning of the material. The energy restoration period appeared on cooling during the liquid-solid transition of the paraffin.

### EXAMPLE 4

50.1 g of KETRUL 220 ® (non aromatic) was mixed with 4.5 g of resin A. 0.5 g of resin B was then added. The mixture was stirred until it was homogeneous and the temperature was kept at 80° C. The time to gelling was a period of about 1 hour which was used to position the gel in the receptacle or flowline. Once in place, the gel set irreversibly in the receptacle or flowline with negligible shrinkage. The kerosene gels of Examples 1 and 4 had the same appearance.

### EXAMPLE 5

82.0 g of (C₁₈-C₂₀) paraffin was added to 11.51 g of resin A and 4.61 g of octadec-1-ene. The mixture was stirred, then 1.15 g of resin B and 0.74 g of a PHMS (polyhydromethylsiloxane) was added. The mixture was stirred until it was homogeneous and the temperature was kept at 80° C. The time to gelling was a period of about ¼ hour which was used to position the gel in the receptacle or flowline. Once in place, the gel set irreversibly in the receptacle or flowline with negligible shrinkage. The energy restoration period appeared on cooling during the liquid-solid transition of the paraffin.

### EXAMPLE 6

82.0 g of (C₁₈-C₂₀) paraffin was added to 15.45 g of resin A and 0.77 g of octadec-1-ene. The mixture was stirred, then 1.55 g of resin B and 0.23 g of a PHMS (polyhydromethylsiloxane) and 20 μl of a catalytic solution of a 2.1-2.4% Pt⁽⁰⁾ divinyl-tetramethyldislixane solution in xylene was added. The mixture was stirred until it was homogeneous and the temperature was kept at 60° C. The time to gelling was a period of about 16 hours, which was used to position the gel in the receptacle or flowline. Once in place, the gel set irreversibly in the receptacle or flowline with negligible shrinkage. The energy restoration period appeared on cooling during the liquid-solid transition of the paraffin. The time available for placing the material was longer than that for Example 5.

### EXAMPLE 7

85.0 g of a KETRUL 212® kerosene (containing 20% aromatics) was added to 12.69 g of resin A and 0.63 g of allylbenzene. The mixture was stirred, then 1.27 g of resin B and 0.41 g of a PHMS (polyhydromethylsiloxane) was added. The mixture was stirred until it was homogeneous and the temperature was kept at 70° C. The time to gelling was a period of about 6 hours which was used to position the gel in the receptacle or flowline. Once in place, the gel set irreversibly in the receptacle or flowline with negligible shrinkage.

### EXAMPLE 8

82.0 g of (C₁₈-C₂₀) paraffin was added to 11.51 g of resin A and 4.61 g of octadec-1-ene. The mixture was stirred, then 1.15 g of resin B and 0.74 g of a PHMS (polyhydromethylsiloxane) and 20 μl of a catalytic solution of 0.5 M H₂PtCl₆6H₂O in tetrahydrofuran (THF) were added. The mixture was stirred until it was homogeneous and the temperature was kept at 70° C. The time to gelling was a period of about 6 hours which was used to position the gel in the receptacle or flowline. Once in place, the gel set irreversibly in the receptacle or flowline with negligible shrinkage. The energy restoration period appeared on cooling during the liquid-solid transition of the paraffin. The time available for positioning the material was intermediate between that for Example 5 and that for Example 6.

1. A method for thermal insulation, characterized in that it comprises:
positioning a gel formed between an insulating liquid base, which may or may not be a phase change material, and at least one gelling agent comprising at least one polysiloxane resin, which may or may not be modified, and
in situ cross linking of said polysiloxane resin.

2. A method according to claim 1, characterized in that said insulating liquid base is selected from:
saturated or unsaturated, cyclic or non-cyclic aliphatic hydrocarbon bases;
aromatic hydrocarbon bases;
mixtures of aliphatic and aromatic fractions;
aliphatic and aromatic alcohols;
fatty acids, vegetable oils and animal oils; and
halogenated compounds.

3. A method according to claim 1, characterized in that said insulating liquid base is a phase change material.

4. A method according to claim 3, characterized in that said insulating liquid base is a C₁₂ to C₆₀ paraffinic cut.

5. A method according to claim 4, characterized in that said insulating liquid base is selected from long chain C₃₀ to C₄₀ n-paraffin waxes and long chain C₃₀ to C₄₀ isoparaffin waxes containing 1 or 2 branches.

6. A method according to claim 3, characterized in that said insulating liquid base is selected from slightly branched alkyl chain alkylaromatics or alkylcycloalkanes, fatty alcohols and fatty acids.

7. A method according to claim 1, characterized in that said insulating liquid base is a kerosene.

8. A method according to claim 1, characterized in that said polysiloxane resin is selected from:
monomers containing a motif with formula (I) terminated by two motifs with formula (II);
oligomers with unitary motifs with formula (I) terminated by motifs with formula (II);
polymers comprising unitary motifs with formula (I) terminated by motifs with formula (II);
cyclic oligomers comprising unitary motifs with formula (I); and
cyclic polymers comprising unitary motifs with formula (I); formulae (I) and (II) being shown below: 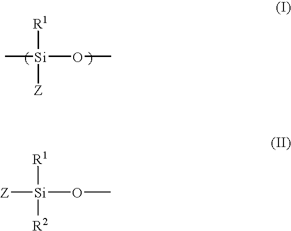
in which formulae:
symbols R¹ and R², which are identical or different, each represent:
a linear or branched alkyl radical containing less than 30 carbon atoms, optionally substituted with at least one halogen;
a cycloalkyl radical containing 5 to 8 carbon atoms in the cycle, optionally substituted;
an aryl radical containing 6 to 12 carbon atoms, which may be substituted; or
any other alkylaromatic chain;
symbols Z, which are identical or different, each represent:
a group R¹ and/or R²;
a hydrogen radical;
a hydroxyl radical;
a vinyl radical (—CH═CH₂); or
a saturated or unsaturated, aliphatic or cyclic carbonaceous chain, which may or may not contain unsaturated bonds, which may or may not contain heteroatoms, which may or may not contain reactive chemical groups;
with at least one of symbols Z representing a cross-linkable group, using one of the cross-linking modes defined below.

9. A method according to claim 1, characterized in that said insulating liquid base represents 70% to 99.5% and said gelling agent represents 30% to 0.5% of the total weight of the mixture.

10. A method according to claim 1, characterized in that the mixture further comprises a compatiblizing agent between said insulating liquid base and said polysiloxane, the proportion of which is included in the proportion of gelling agent.

11. A method according to claim 1, characterized in that the gelling agent comprises at least one polyorganosiloxane terminated by hydroxyl functions and at least one silane containing alkoxy functions or carboxylate groups and cross-linking is carried out in the presence of an acid catalyst, a basic catalyst or a catalyst based on tin or titanium in the presence of traces of water acting as a co-catalyst.

12. A method according to claim 1, characterized in that the gelling agent comprises two functionalized polysiloxanes:
a resin A containing vinylsilane functions (Si—CH═CH₂) which may be grafted;
and a resin B containing hydrosilane functions (Si—H); and in that cross-linking is carried out by hydrosilylation.

13. A method according to claim 12, characterized in that the proportions of resins A and B are such that the mole ratio between the hydrosilane groups from resin B and the vinylsilane groups from resin A is 0.8 to 1.4.

14. A method according to claim 12, characterized in that the mixture comprises a hydrosilylation catalyst.

15. A method according to claim 12, characterized in that said insulating liquid base generally represents 50% to 99.5% of the total mixture weight and the gelling agent represents 0.5% to 50%.

16. A method according to claim 15, characterized in that said insulating liquid base represents 70% to 98% and said gelling agent represents 2% to 30% of the total mass of the mixture.

17. A method according to claims 12, characterized in that the mixture further comprises a compatibilizing agent between said insulating liquid base and said polysiloxane, the proportion of which is included in the proportion of gelling agent.

18. A method according to claim 12, characterized in that said insulating liquid base is a C₁₂ to C₆₀ paraffinic cut, the proportion of gelling agent, which includes that of the compatibilizing agent, is 7% to 30% by weight, in which the compatibilizing agent represents a proportion of 10% to 40% by weight.

19. A method according to claim 18, characterized in that said insulating liquid base is a C₁₄ to C₂₀ paraffinic cut and the compatibilizing agent is octadec-1-ene.

20. A method according to claim 12, characterized in that said insulating liquid base is a kerosene and in that the gelling agent represents 5% to 30% by weight of the mixture.

21. A method according to claim 1, characterized in that the positioning time for said mixture is regulated by the temperature, the nature and the proportion of resin in said mixture and by the nature and concentration of any catalyst in said mixture.

22. A method according to claim 1, characterized in that the mixture further comprises at least one additive selected from antioxidant additives, antibacterial agents, corrosion inhibitors, anti-foaming agents and colorants, which are soluble in the insulating liquid base.

23. A method according to claim 1, characterized in that the mixture further comprises at least one filler selected from hollow glass microbeads, fly ash, macrobeads and hollow fibres.

24. A method according to claim 1, characterized in that a flowline or a pipeline or a singularity on a flowline or pipeline is insulated.

25. A method according to claim 24, characterized in that an ultradeep pipeline is insulated for temperatures of 2° C. to 200° C.

26. A method according to claim 24, characterized in that the mixture is applied as a coating to the flowline to be thermally insulated.

27. A method according to claim 24, characterized in that the mixture is interposed between the flowline and a protective external jacket.

28. A method according to claim 24, characterized in that said singularity consists of a bend, a tee, a valve or an automatic connector.

29. A method according to claim 28, characterized in that the singularity is on a flowline already in place on the seabed; a vacuum is created in said jacket to purge as much water as possible that it may contain; the mixture is injected into the jacket to inflate it and to create the desired insulation around said singularity.

30. A flowline or pipeline thermally insulated by a method according to claim 23.

31. A cross-linkable formulation for use in a method according to claim 1, characterized in that it comprises a mixture of an insulating liquid base, which may or may not be a phase change material, and at least one gelling agent comprising at least one polysiloxane, which may or may not be modified.

32. An insulating gel formulation according to claim 31, characterized in that the mixture further comprises a compatibilizing agent between said insulating liquid base and said polysiloxane.

33. An insulating gel formulation according to claim 31, characterized in that the gelling agent comprises two functionalized polysiloxan resins:
a resin A containing vinylsilane functions (Si—CH═CH₂) which may be grafted;
and a resin B containing hydrosilane functions (Si—H).

34. A process for producing an insulating gel from a formulation according to claim 31, characterized in that said formulation is subjected to cross-linking conditions.

35. A process according to claim 34, characterized in that in step a), a compatibilizing agent acting between said insulating liquid base and said polysiloxane is employed.

36. A process according to claim 34, characterized in that the gelling agent comprises two functionalized polysiloxanes:
a resin A containing vinylsilane functions (Si—CH═CH₂) which may be grafted;
and a resin B containing hydrosilane functions (Si—H); and in that cross-linking is carried out by hydrosilylation.

37. An insulating gel, characterized in that it is formed from an insulating liquid base and at least one cross-linked polysiloxane resin.

38. An insulating gel, characterized in that it is obtained by a process according to claim 34.

39. A flowline or pipeline thermally insulated using a gel according to claim 37.

40. A flowline or pipeline according to claim 39, characterized in that said gel is applied to the flowline to be thermally insulated as a coating.

41. A flowline or pipeline according to claim 39, characterized in that said gel is interposed between the flowline and a protective external jacket.
